(19) United States
(12) Patent Application Publication
(10) Pub. No.: US 2005/0091906 A1
(43) Pub. Date: May 5, 2005

(54) Fishing rod lure protector

(76) Inventor: James D'Alusio, Brick, NJ (US)

Correspondence Address: Charles I. Brodsky, Esq., 2 Bucks Lane, Marlboro, NJ, 07746, US

(21) Appl. No.: 10/700,727

(22) Filed: Nov. 4, 2003

(51) Int. Cl. A01K 97/06

(52) U.S. Cl. 43/25.2

(57) ABSTRACT

A non-skin penetrative grasping means, preferably in the form of a plastic hook, extends outwardly from an openable case which fully encloses a fishing lure on its line, with the hook then being coupled to one of a reel of a fishing rod/pole combination and of an eyelet line guide thereon.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the sport and hobby of fishing, in general, and to the protection of the artificial lures used therein, in particular.

2. Description of the Related Art

As will be appreciated, of all those people who participate in the sport and hobby of fishing, very few have been observed to remove their artificial lures from their lines at the end of the day's activities. As likewise the situation in the instance where only hooks with live bait are employed—rather than single or multiple-hook artificial lures—, the tendency is almost always to leave the last set-up intact for the next time. So as to prevent the hooks or lures from swinging about and possibly causing injury to one nearby when returning from the water's edge, the practice usually is to extend the line so that the hook or lure is held taut by the reel on the fishing rod/pole combination or by an eyelet line guide thereof.

While in theory that should work perfectly well, in actual use the hooks and guides tend to come loose just from the vibrations of walking about to the car, truck, deck or campsite—and usually so when just being thrown into the back of a vehicle due to the vibrations attendant with driving over the road. In either event, the swinging-about of the hook or lure almost always creates the possibility of someone being stuck by the hook—or, at the very least, the damaging of the lure's attracting surface in banging against the various inside and outside surfaces of the vehicle. Anyone who has been stuck by a fish hook or by the hook(s) of the artificial lure will appreciate the pain associated with it, while the fishing sport enthusiast will further appreciate the deleterious effects which might result from a disfigurement or marring of the lure's surface.

### OBJECTS OF THE INVENTION

It is an object of the present invention, therefore, to provide apparatus to protect against the accidental sticking of one's skin by the hook(s) of an artificial fishing lure and of any other hooks on the fishing line, in general.

It is an object of the invention, also, to provide such protection in a manner which at the same time serves to protect the hook(s) from being damaged by an accidental knocking into any hard surface.

It is another object of the invention to provide such protective apparatus in a manner which is simple to implement, and at an inexpensive cost.

It is yet a further object of the invention to provide such protective apparatus no matter the type of artificial lure being employed, and in a manner to address the various sizes and configurations such lures may take.

### SUMMARY OF THE INVENTION

As will become clear from the following description, in a fishing rod/pole lure protector, apparatus according to the invention includes an openable case having first and second facing sections forming the case when closed towards one another, with each of the sections being of predetermined length, width and depth dimensions. A non-skin penetrative grasping means is included at an edge surface of one of the facing sections, extending outwardly from the case when closed. An aperture on the case remote from the edge surface is additionally included, of a cross-section to admit entry of a fishing line lengthwise into the case once closed.

In preferred embodiments of the invention, the grasping means may include a non-skin penetrative hook, of plastic composition. To keep relative manufacturing costs low, the first and second facing sections may each be of a plastic composition—preferably see-through. For the opening and closing of the two facing sections, any type of hinge coupling may be employed.

To afford the protection desired, the two facing sections are selected of length, width and depth dimension to fully enclose the artificial fishing lure once the sections are closed together. With the grasping means in the nature of the above noted hook, its coupling to one of a reel of the fishing rod/pole combination and of an eyelet line guide on the rod/pole then holds everything in place so that the lure does not flap or swing about. The plastic case then fully encloses the lure coupled to the line, with the line gaining entry into the case through the positioned aperture of appropriate cross-section. By constructing the non-skin penetrative hook and the two facing sections of plastic, an inexpensive manufacture could be had, resulting in a reasonably affordable protector being available for wide-spread consumer purchase.

### BRIEF DESCRIPTION OF THE DRAWINGS

These and other features of the present invention will be more clearly understood from a consideration of the following description, taken in connection with the accompanying drawings, in which:

FIGS. 1 & 2 are pictorial views of a fishing rod-reel combination with an artificial lure attached, helpful in an understanding of the need for the present invention;

FIGS. 3A and 3B are opened and closed views of a plastic case embodying the invention, with FIG. 3C being a side view of the case when closed; and

FIG. 4 is a pictorial view of a fishing rod/pole with the case of the invention in place about an artificial lure.

### DETAILED DESCRIPTION OF THE INVENTION

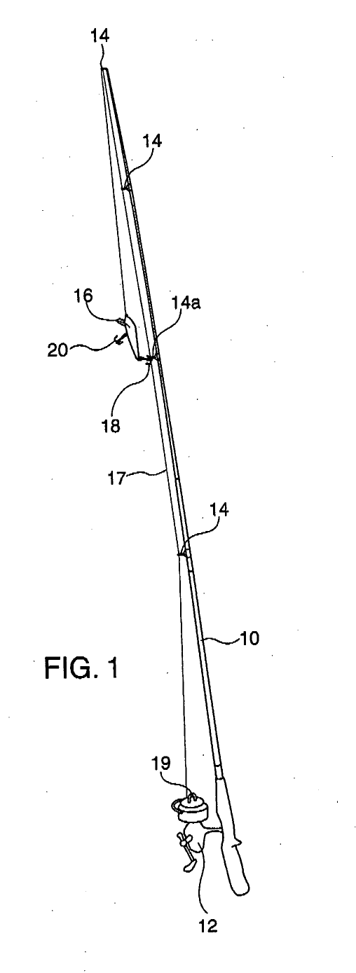

In the prior art drawings of FIGS. 1 and 2, a fishing rod/pole 10, with attached reel 12 is provided with a plurality of eyelet line guides 14 for fishing with an artificial lure 16 having multiple hooks 18, 20. When not being used, the reel 12 typically is wound to hold a mono-filament line 17 taut by coupling either of the hooks 18, 20 about the guide 14. Whether the artificial lure 16 be of the floating, countdown, or jointed variety, however, many occasions arise where the hook(s) detach from the guide 14 in allowing the lure 16 to swing about, possibly causing injury to those nearby. Even when not so possible, just throwing the rod/reel combination when arranged this way into a vehicle could cause damage to the surface of the lure itself or to its multiple hooks.

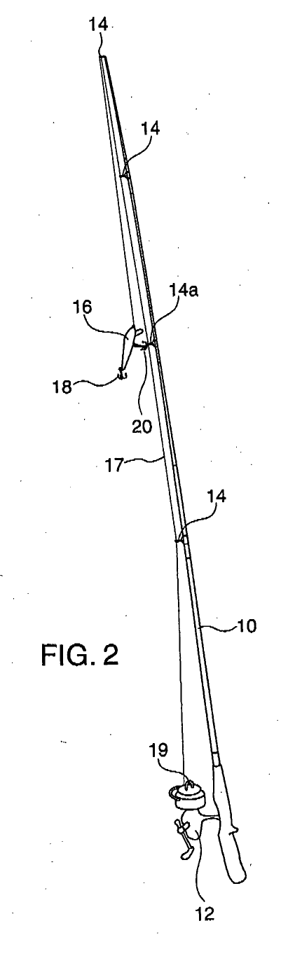

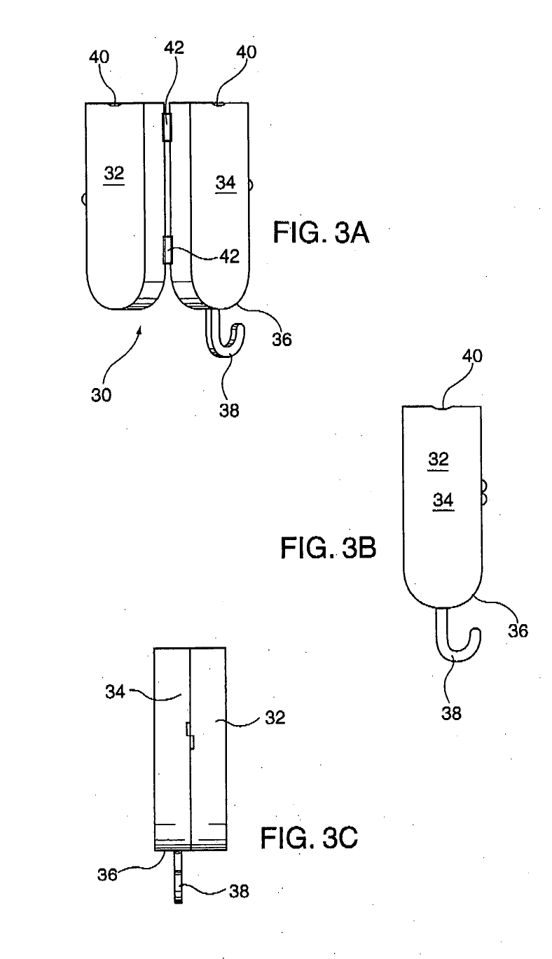

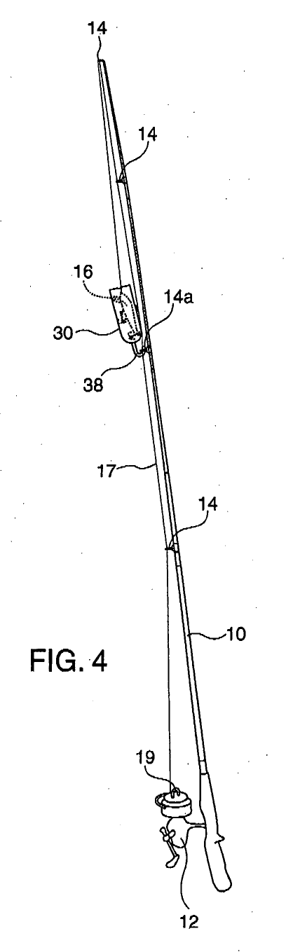

In accordance with the invention, on the other hand, an openable case is provided to enclose the lure and its hooks. Such case 30 has, as shown in FIGS. 3A-3C and in FIG. 4, first and second facing sections 32, 34 which form the case 30 when closed towards one another, with each of the sections 32, 34 being of predetermined length, width and depth dimensions. Preferably of a plastic composition to keep costs low—and of a see-through plastic composition for that matter—, the case 30 is provided with an edge surface 36 having a non-skin penetrative grasping means 38 (for example, a non-skin penetrative plastic hook) extending outwardly from the case 30 when closed.

As will be seen in FIG. 4, such grasping means can couple to an eyelet line guide 14a—or, alternatively, could couple to the reel 12, as at 19. With the facing sections 32, 34 being of selected length, width and depth dimensions, the lure 16 could then fit fully enclosed inside of, and be protected by, the case 30. As FIGS. 3A, 3B and 4 illustrate, the case 30 further includes an aperture 40 remote from the edge surface 36, of a cross-section to admit the entry of the fishing line 17 lengthwise into the case to join with the nose end 21 of the artificial lure 16. The case 30 thus surrounds the lure 16 in protecting both its multiple hooks 18, 20 and its decorative surface—yet also protects anyone who may be walking near the rod-reel combination should the lure 16 release from the couplings holding it taut when not in use, as with the situations of FIGS. 1 and 2.

Such facing sections 32, 34 may be hinged apart at 42, to open the case 30 in freeing the lure 16 when the hook 38 is released and fishing is to occur. Likewise, the facing sections 32, 34 can be hinged together at 42 when putting the rod/reel combination away for later use—at such time, coupling the hook 38 to either the eyelet line guide 14a or at 19 on reel 12. As will be appreciated, once the case 30 is opened, a different lure could be placed on the line 17, and either the same or different size case 30 thereafter used when the fishing activity is over, depending upon the type and size of the lure to be enclosed. Again, the grasping hook 38 is emplaced as described, the reel 12 wound to tighten the line 17, and the case 30 then closed about the lure 16 to hold it in place. Alternatively, and as will be understood, the facing sections 32, 34 could be closed first, and the line 17 which then passes through the aperture 38 could then be wound to provide the tightened position illustrated in FIG. 4.

Essentially then, the artificial lure 16 (or just a plain hook, if one is to be employed with live bait instead of using an artificial lure) is kept enclosed within the protective covering case 30 when not being used, with the coupling to the rod or reel being by the protecting hook 38. Potential personal injury could then be avoided, and with the protection of the lure being maintained by the nature of the case enclosure.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

1-4. (canceled)

5. The apparatus of claim 9 wherein each of said first and second facing sections are of a see-through plastic composition.

6. (canceled)

7. In a fishing rod/pole lure protector, apparatus comprising:
an operable plastic case having first and second facing sections forming said case when closed towards one another, with each of said sections being of predetermined length, width and depth dimensions;
a fixed non-skin penetrative plastic hook included as part of an edge surface of one of said facing sections, extending outwardly from said case when closed; and
an aperture on said case remote from said edge surface, of cross-section to admit entry of a fishing line lengthwise into said case once closed:
wherein said first and second facing sections are hinged together for the opening and closing of said case; and
wherein said first and second facing sections are selected of length, width and depth dimensions to fully enclose a fishing lure when said sections are closed together.

8. (canceled)

9. The apparatus of claim 7, also including an enclosed lure coupled with said fishing line admitted into said case through said aperture; and wherein said non-skin penetrative plastic hook is coupled to one of a reel of a fishing rod/pole combination and of an eyelet line guide thereon.

10-14. (canceled)
